(19) United States
(12) Patent Application Publication
(10) Pub. No.: US 2009/0150328 A1
(43) Pub. Date: Jun. 11, 2009

(54) IMAGE METADATA HARVESTER

(75) Inventor: David Michael Silver, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/950,430

(22) Filed: Dec. 5, 2007

(51) Int. Cl. G06F 17/30

(52) U.S. Cl. 707/1; 707/E17.001

(57) ABSTRACT

New metadata may be created based on data associated with a digital image file. A digital image file may include a digital image as well as metadata, which may be descriptive of the digital image. An application executing on a processing device may define a policy specifying the new metadata to be created, methods for creating the new metadata, and data sources of information used to derive the new metadata, as well as other information. Harvesters may harvest data according to the defined policy. A harvest manager may load and invoke harvesters, as requested by the application. The harvest manager may further determine whether the loaded harvesters are to use input provided by other unloaded harvesters and may automatically load the other unloaded harvesters, accordingly. The newly created metadata may be stored in the digital image file, a data set associated with the digital image file, and/or another location.

### BACKGROUND

Traditionally, querying or searching digital image files had been difficult because the digital image files may not contain textual data. However, digital image files may include embedded metadata. Some of the metadata, such as, for example, a date and a time at which an image included in a digital image file is captured, may automatically be included in the digital image file when the digital image is captured by a digital camera or other image capturing device. The metadata may be saved as exchangeable image file format (EXIF) type metadata. This is one of many standard formats in which metadata may be stored within the digital image file. The digital image file may also include other metadata, which may be added by a user. The other metadata may be in an EXIF metadata block, or in another format type, such as International Press Telecommunications Council (IPTC) metadata, or Extensible Metadata platform (XMP), developed by Adobe Systems Incorporated of San Jose, Calif.

A professional or semi-professional photographer may capture thousands of digital images in digital image files. The professional or semi-professional photographer may add IPTC type metadata or other types of metadata to the digital image files to make querying or searching for particular digital image files easier. However, adding IPTC type metadata or other types of metadata to thousands of digital image files may be tedious and very time-consuming. As a result, the professional or semi-professional photographer may avoid adding the IPTC type metadata or other types of metadata to the digital image files.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a method and a processing device may be provided. The processing device may have access to a digital image included within a digital image file. The digital image file may include metadata associated with the digital image. An application executing on the processing device may define a policy or may select a policy from among a group of policies. The policy may specify one or more sources of data to be harvested, as well as methods for creating new metadata. The application may define or select the policy via an application programming interface (API). The application may further specify harvesters to be loaded and invoked. The harvesters may harvest data from one or more data sources based on metadata associated with the digital image file, or based on bits of a digital image included in the digital image file. The harvester may create and store new metadata, based on the harvested data, using methods specified by the policy. A harvester manager may determine whether the specified harvesters are to use input from one or more other unloaded harvesters and may load the one or more other unloaded harvesters, accordingly.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an exemplary operating environment for embodiments consistent with the subject matter of this disclosure.

FIG. 2 is a functional block diagram of an exemplary processing device, which may implement a processing device and/or a server shown in FIG. 1.

FIG. 3 is a functional block diagram illustrating functions, which may be performed in a processing device in embodiments consistent with subject matter of this disclosure.

FIGS. 4-6 are flowcharts of exemplary processes, which may be implemented in embodiments consistent with the subject matter of this disclosure.

### DETAILED DESCRIPTION

Embodiments are discussed in detail below. While specific implementations are discussed, it is to be understood that this is done for illustration purposes only. A person skilled in the relevant art will recognize that other components and configurations may be used without parting from the spirit and scope of the subject matter of this disclosure.

### Overview

Embodiments consistent with the subject matter of this disclosure may provide a processing device and a method for creating and storing metadata associated with digital images included within digital image files. A processing device may have access to a digital image included within a digital image file. The digital image file may include metadata associated with the digital image. The metadata may include EXIF type metadata, IPTC type metadata, XMP type metadata, or other types of metadata.

A policy may be specified to indicate data to be harvested with respect to the digital image file. The policy may specify one or more sources of the data to be harvested, such as, for example, image metadata (EXIF type metadata, XMP type metadata, IPTC type metadata or other types of metadata) included in the digital image file, data from one or more applications which may execute on the processing device, data from a remote server or a service accessible via a network, or other data sources. The policy may further include methods for creating new metadata based on the data to be harvested. For example, the digital image file may include a block of EXIF type metadata called “DateTimeOriginal”, which may include a date and a time at which a digital image, included in the digital image file, was captured. The digital image file may also include a block of IPTC type metadata called “DateTimeTaken”, which may similarly include a date and a time associated with the digital image. The policy may specify that new metadata, called “DateTime”, is to be created from the block of EXIF type metadata called “DateTimeOriginal”, if “DateTimeOriginal” exists. If “DateTimeOriginal” does not exist, then “DateTime” is to be created from the block of IPTC type metadata “DateTimeTaken”, if “DateTimeTaken” exists. The newly created metadata may be stored in the digital image file, in a dataset associated with the digital image file, and/or in another location.

The policy may further include methods for creating new metadata based on data harvested from other sources, such as, for example, data from one or more applications, data from one or more servers or network services, and/or other data sources.

The policy may be specified by an application via an application programming interface (API). In some embodiments, the application may select the policy from a group of predefined policies via the API.

A harvester may harvest data from one or more data sources based on metadata associated with a digital image file, or based on a digital image included within the digital image file, as specified by the policy. The harvester may create and store new metadata based on the harvested data, as specified by the policy.

An application may specify, via the API, one or more harvesters to be loaded and invoked. The specified one or more harvesters may be loaded and a harvester manager may determine whether any of the one or more harvesters expect input from one or more other unloaded harvesters. If the harvester manager determines that one or more harvesters expect input from one or more other unloaded harvesters, then the one or more other harvesters may be loaded before invoking the one or more harvesters specified by the application. In some embodiments, the one or more harvesters and the one or more other harvesters may be loaded and invoked automatically when a digital image file is opened.

### Exemplary Operating Environment

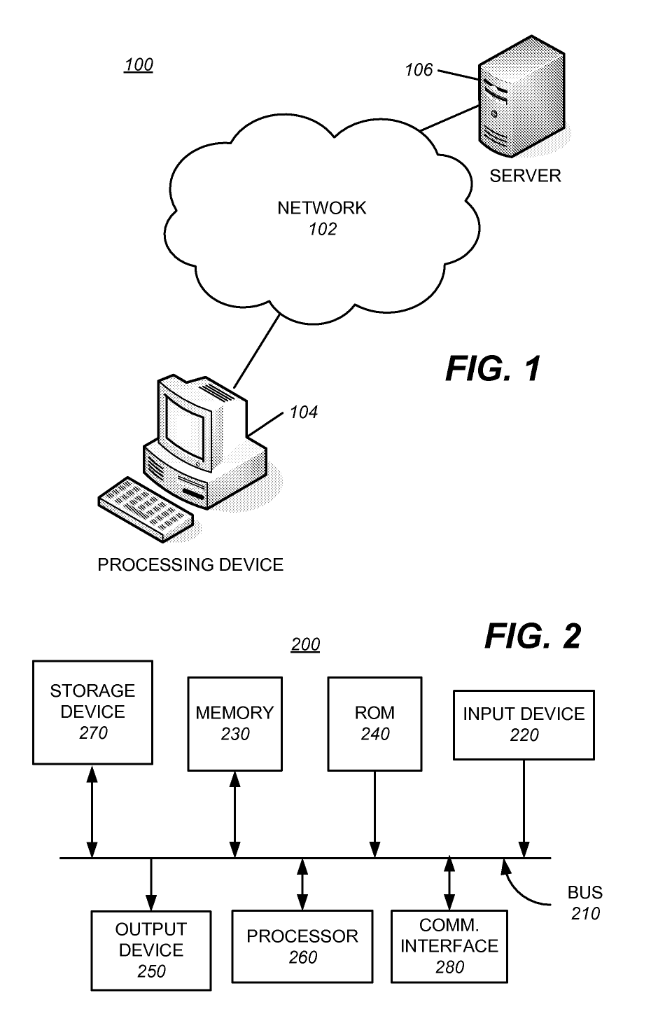

FIG. 1 illustrates an exemplary operating environment 100 consistent with the subject matter of this disclosure. Exemplary operating environment 100 may include a network 102, a processing device 104 and a server 106.

Network 102 may be a single network or a combination of networks, such as, for example, the Internet or other networks. Network 102 may include a wireless network, a wired network, a packet-switching network, a public switched telecommunications network, a fiber-optic network, other types of networks, or any combination of the above.

Processing device 104 may be a processing device, such as, for example, a desktop personal computer (PC), a laptop PC, a handheld processing device, or other processing device.

In some embodiments, server 106 may include multiple servers configured to work together as a server farm.

### Exemplary Processing Device

FIG. 2 is a functional block diagram of an exemplary processing device 200, which may be used in embodiments consistent with the subject matter of this disclosure to implement processing device 104 and/or server 106. Processing device 200 may include a bus 210, an input device 220, a memory 230, a read only memory (ROM) 240, an output device 250, a processor 260, a storage device 270, and a communication interface 280. Bus 210 may permit communication among components of processing device 200.

Processor 260 may include at least one conventional processor or microprocessor that interprets and executes instructions. Memory 230 may be a random access memory (RAM) or another type of dynamic storage device that stores information and instructions for execution by processor 260. Memory 230 may also store temporary variables or other intermediate information used during execution of instructions by processor 260. ROM 240 may include a conventional ROM device or another type of static storage device that stores static information and instructions for processor 260. Storage device 270 may include a compact disc (CD), digital video disc (DVD), a magnetic medium, or other type of storage device for storing data and/or instructions for processor 260.

Input device 220 may include a keyboard, a joystick, a pointing device or other input device. Output device 250 may include one or more conventional mechanisms that output information, including one or more display monitors, or other output devices. Communication interface 280 may include a transceiver for communicating over one or more networks via a wired, wireless, fiber optic, or other connection.

Processing device 200 may perform such functions in response to processor 260 executing sequences of instructions contained in a tangible machine-readable medium, such as, for example, memory 230, ROM 240, storage device 270 or other medium. Such instructions may be read into memory 230 from another machine-readable medium or from a separate device via communication interface 280.

### Exemplary Functional Block Diagram

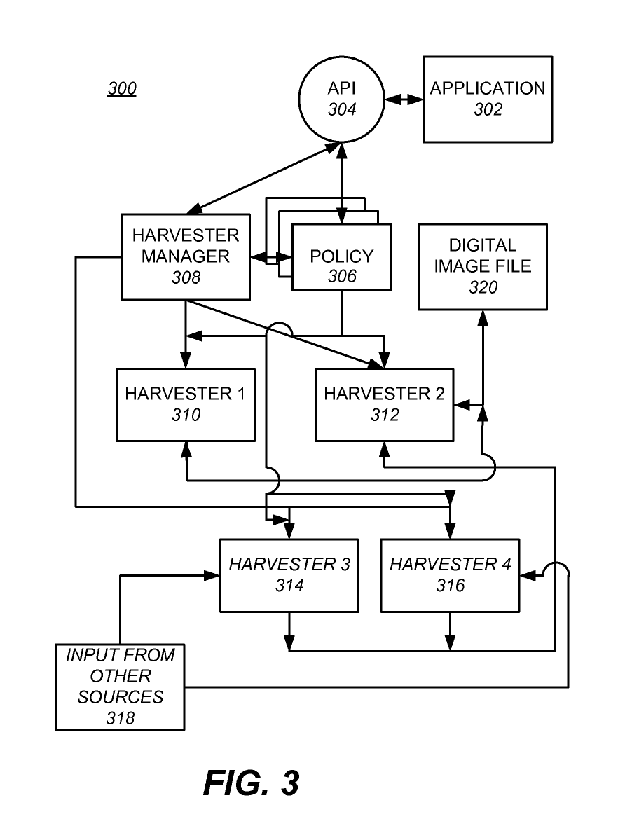

FIG. 3 is an exemplary functional block diagram 300, which helps to explain processing in a processing device, such as, for example, processing device 104, consistent with the subject matter of this disclosure. Processing device 104 may include an application 302, an API 304, one or more policies 306, a harvester manager 308, harvesters 310-316, access to other data sources 318, and a digital image file 320.

Application 302 may make calls to API 304 to request or define a policy 306, which may include metadata to be created, methods for creating the metadata from harvested data, one or more data sources for the harvested data, as well as other information. In one embodiment, processing device 104 may include a number of predefined policies 306, one of which may be selected by application 302 by making a call via API 304. Application 302 may further make a call to harvester manager 308, passing harvester manager 308 information regarding one or more harvesters 310-316 to load and invoke.

Harvester manager 308 may load the one or more harvesters 310-316 and may analyze the one or more harvesters 310-316 to determine whether any of the one or more harvesters 310-316 use input from one or more unloaded harvester. Harvest manager 308 may make the determination based on information included in the loaded harvesters 310-316, with reference to the defined or selected policy 306. For example, harvest manager 308 may refer to policy 306 and determine that a loaded harvester may use input provided by an unloaded harvester. If harvest manager 308 determines that input from one or more unloaded harvesters is to be used by any of the one or more harvesters 308-316, then harvester manager 308 may load the determined one or more unloaded harvesters. Harvest manager 308 may then invoke the one or more harvesters 308-316 associated with the information passed from application 302 to harvest manager 308, as well as the determined one or more unloaded harvesters. At least some of harvesters 310-316 may harvest data from metadata included in digital image file 320. Others of harvesters 310-316 may harvest data from one or more other data sources, such as other applications, databases, servers, network services, or other data sources. In exemplary functional block diagram 300, harvesters 310, 312 harvest data based on a digital image file 320 and receive data provided by harvesters 314 and 316. Harvesters 314 and 316 may harvest data from other sources 318.

Functional block diagram 300 is only exemplary. In other embodiments, other arrangements of harvesters and data sources may be implemented. For example, more or fewer harvesters may be employed. In some embodiments, harvesters may access policy 306 and digital image file 320 via an API, such as, for example, API 304, or another API. Of course numerous other arrangements or configurations may be employed.

### Exemplary Processing

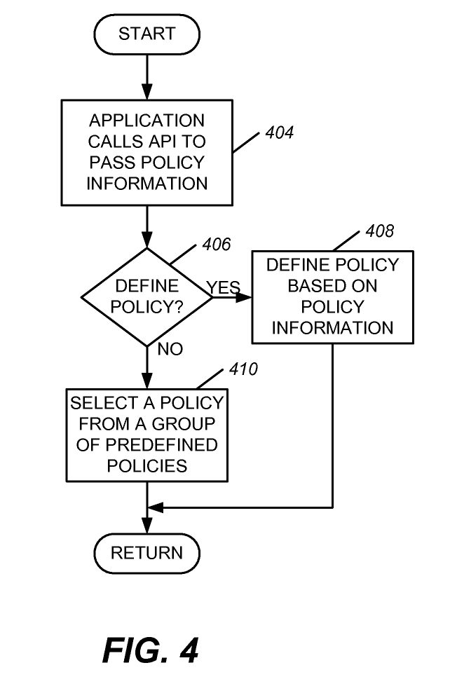

FIG. 4 is a flowchart illustrating an exemplary process, which may be executed in embodiments consistent with the subject matter of this disclosure, for defining or selecting a policy. The process may begin with application 302, executing within processing device 104, calling API 304 to pass information with respect to policy 306 to either define policy 306 or select policy 306 from a group of predefined policies (act 404). Policy 306 may include: information with respect to data, which may be harvested; data sources from which the data may be harvested; new data, which may be created; methods for creating the new data from the harvested data; and/or other information. In some embodiments, application 302 may pass information to policy 306 via API 304 to specify one or more harvesters to be loaded and invoked automatically when a digital image file is opened.

Processing device 104 may then determine whether application 302 is defining policy 306 (act 406). If application 302 is defining policy 306, then processing device 104 may create or define policy 306 based on the information provided by application 302 during act 404 (act 408) and may activate the policy. If, instead, application 302 is selecting policy 306 from among a group of predefined policies, then selected policy 306 may be activated (act 410).

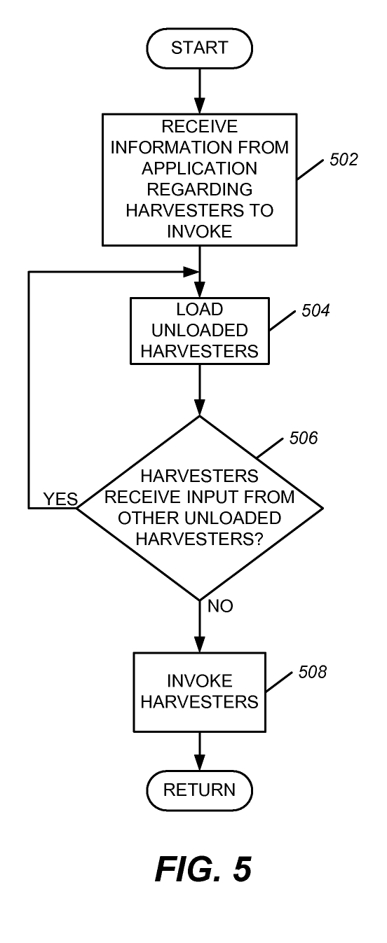

FIG. 5 is an exemplary process which may be performed by harvester manager 308 in embodiments consistent with the subject matter of this disclosure. The process may begin with harvester manager 308 receiving information from application 302 via API 304 regarding harvesters to invoke (act 502). Harvester manager 308 may then load the unloaded harvesters that application 302 requested be invoked (act 504). Harvester manager 308 may then analyze the loaded harvesters, with reference to activated policy 306 to determine whether any additional harvesters are to be loaded to provide input to the loaded harvesters (act 506).

If additional harvesters are to be loaded, then harvester manager 308 may again perform act 504 to load the additional harvesters. Otherwise, harvester manager 308 may invoke all of the loaded harvesters (act 508).

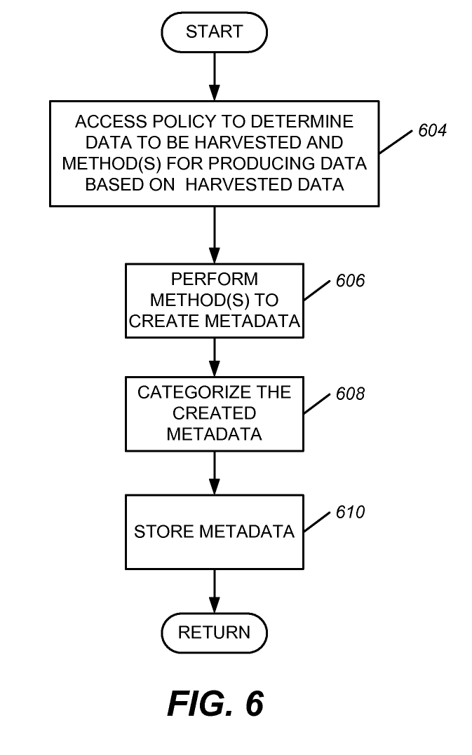

FIG. 6 is an exemplary process which may be performed by a harvester in embodiments consistent with the subject matter of this disclosure. The process may begin with the harvester accessing policy 306 to determine which data are to be harvested and method(s) for creating new metadata based on the harvested data (act 604). Policy 306 may include information describing data to be harvested and sources of the data, harvesters for harvesting the data to be harvested, and method(s) for creating metadata from harvested data, as well as other information. In some embodiments, the harvester may access information with respect to policy 306 via API 304.

The harvester may then harvest data and perform the method(s) to create the new metadata (act 606). Some harvesters may harvest data for use by other harvesters and may not, by themselves, create metadata. Such harvesters may not perform act 606. Other harvesters may provide information related to the digital image file, such as, for example, metadata included in the digital image file, bits of a digital image included in the digital image file, or other information, for example, to a second application or a network service, which, in response, may provide data to the harvesters. The harvesters may use the provided data to create metadata or the harvesters may make the provided data available to other harvesters.

The harvester may categorize the newly created metadata, if any (act 608). For example, newly created metadata may be categorized as intrinsic, if the newly created metadata is derived entirely based on data intrinsic to an image file. Newly created metadata derived, at least partly, based on data from one or more external data sources, may be classified as extrinsic. In other embodiments, the newly created metadata may be categorized into additional or different categories.

The harvester may store the newly created metadata, if any (act 610). The newly created metadata may be stored in the digital image file, in a data set or database associated with one or more digital images, or in another location.

### Data Harvesting Examples

The following are data harvesting examples, which may be performed in embodiments consistent with the subject matter of this disclosure. The examples are only exemplary. Data harvesting may be performed in numerous other ways in other embodiments consistent with the subject matter of this disclosure.

In one example, a policy may be defined to create metadata, called “Copyright”, for an image in a digital image file. The policy may specify that metadata for “Copyright” may be created from: a date reference in the image file, such as, for example, metadata called “DateTimeOriginal”; and metadata, called “Author”, in the digital image file, which may contain a name of an author. The policy may specify that a harvester is to harvest the metadata included in “DateTimeOriginal” and “Author” to create the metadata for “Copyright”, which may have a format of “Copyright <author's name>, <year>. All rights reserved.”, where “<author's name>” is the name of the author from “Author” and “<year>” is the year from “DateTimeOriginal”.

In a variation of the above example, the policy may specify that metadata called “Author” may be created from user input, from a currently logged on user's name, or from other sources.

In a second example, digital image files may include a tag for metadata, called “Description”, which may typically be set manually. Many photographers may use a scheduling application, such as Microsoft Outlook® (registered trademark of Microsoft Corporation of Redmond, Wash.), or another scheduling application. The scheduling application may have an appointment field, which may include a description of an appointment. The policy may specify that a harvester is to harvest data with respect to a date and a time that a digital image was captured, such as, for example, “DateTimeOriginal”, or a similar item of metadata. The harvester may interface with the scheduling application and may request information with respect to the appointment field for an appointment coinciding with the date and the time that the digital image was captured. The harvester may receive information from the scheduling application and may copy the information to “Description”, where the information may be stored.

In a third example, a digital image file may contain a metadata field for GPS data or location data. The GPS data may be created by an application when a digital image is captured, or may be manually added at a later time. The location data also may be manually added. Typically, a digital image file may include either GPS data or location data, but not both. A policy may be defined, such that a harvester may determine that location data does not exist with respect to a digital image file, but that GPS data does exist. The harvester may harvest the GPS data from the digital image file, according to the policy, and may use the GPS data to look up information in, for example, an online search engine, to derive corresponding location data. The harvester may then create and store the looked up information in the metadata field for the location data in the digital image file. Conversely, the harvester may determine that GPS data does not exist with respect to the digital image file, but that location data does exist. The harvester may then harvest the location data from the digital image file, according to policy, and may use the location data to look up information in the online search engine to derive corresponding GPS data. The harvester may then create and store the looked up information in the metadata filed for the GPS data in the digital image file.

In a third example, data may be derived from bits of a digital image included in a digital image file. As defined by the policy, a harvester may provide the bits of the digital image to a face recognition application. In response, the face recognition application may provide text, including one or more names corresponding to recognized faces of the digital image. The harvester may then create and store the one or more names into corresponding metadata fields within the digital image file, a corresponding data set, or another location.

In a forth example, a harvester may provide bits of a digital image included in a digital image file to an application, which may determine a tone of an image and whether a scene of the digital image is an outdoor scene. Based on information provided by the application, such as, for example, dark tone and outdoor scene, as well as date and time information, which may be stored in metadata fields of the digital image file, the harvester may determine that the digital image is a sunset scene and may create and store text, such as, “sunset scene” in a description field within metadata stored in the digital image file.

### Conclusion

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents define the invention, rather than any specific examples given.

I claim as my invention:

1. A machine-implemented method for harvesting data based on data associated with a digital image file, the method comprising:
permitting a policy to be defined, the policy defining creation of new data based, at least partly, on the data associated with the digital image file;
harvesting data according to the policy; and
creating the new data based on the harvested data.

2. The machine-implemented method of claim 1, wherein the permitting of a policy to be defined further comprises:
defining, by an application, a method for deriving the new data based on the harvested data.

3. The machine-implemented method of claim 1, wherein:
the harvesting of data according to the policy further comprises:
retrieving, by an application via an application program interface, the data from at least one data source according to the policy, and the machine-implemented method further comprises:
storing at least a portion of the created new data as new metadata according to the policy.

4. The machine-implemented method of claim 1, wherein the policy defines creation of the new data based entirely on the data associated with the digital image file.

5. The machine-implemented method of claim 1, wherein the policy defines creation of the new data based, at least in part, on data from at least one source other than the digital image file.

6. The machine-implemented method of claim 1, wherein:
the data includes a date and a time a digital image of the digital image file was captured, and
the new data includes data from a scheduling application corresponding to the date and the time the digital image of the digital image file was captured.

7. The machine-implemented method of claim 1, wherein:
the data associated with the digital image file includes GPS data with respect to a location corresponding to a scene included in a digital image of the digital image file, and
the new data includes location information corresponding to the GPS data, the new data being harvested from a network server.

8. A processing device comprising:
an application program interface to permit an application to define or select a policy; and
at least one harvester to harvest data according to the policy, the harvested data being based on data associated with a digital image file, the at least one harvester being configured to create and store at least one new item of metadata from the harvested data according to the policy, the policy defining one or more methods for creating the at least one new item of metadata from the harvested data.

9. The processing device of claim 8, wherein one of the at least one harvester is configure to store at least one of the at least one new item of metadata in the digital image file.

10. The processing device of claim 8, further comprising:
a harvester manager configured to load at least one other harvester when one of the at least one harvester is configured to receive input from the at least one other harvester.

11. The processing device of claim 8, comprising:
a plurality of predefined policies, each of the predefined policies defining at least one respective method for creating at least one corresponding new item of metadata from the harvested data, wherein
the application program interface permits the application to select one of the plurality of predefined policies as the policy.

12. The processing device of claim 8, wherein one of the at least one harvester is configured to:
provide at least one first item of data, based on at least some of the metadata associated with the digital image file, to a second application, and
receive at least one second item of data from the second application in response to providing the at least one first item of data.

13. The processing device of claim 8, wherein the at least one harvester is configured to:
provide bits of a digital image of the digital image file to a facial recognition application,
receive at least one item of data from the facial recognition application in response to providing the bits the digital image to the facial recognition application, the at least one item of data including a name corresponding to at least one face included in the digital image, and
create and store the at least one name as at least a portion of the at least one new item of metadata associated with the digital image file.

14. The processing device of claim 8, wherein one of the at least one harvester is configured to:
receive items of data from a plurality of data sources.

15. The processing device of claim 8, wherein:
the application program interface further permits the application to specify the at least one harvester to be invoked automatically when the digital image file is opened.

16. A tangible machine-readable medium having instructions recorded thereon for at least one processor, the instructions comprising:
instructions for defining a policy or selecting the policy from a plurality of predefined policies;
instructions for invoking at least one harvester to harvest data, according to the policy, from a plurality of data sources based on a digital image file, the policy specifying at least one method for creating at least one new item of metadata from the harvested data; and
instructions for storing the at least one new created item of metadata.

17. The tangible machine-readable medium of claim 16, wherein the instructions for automatically invoking the at least one harvester further comprise instructions for automatically invoking the at least one harvester when the digital image file is opened.

18. The tangible machine-readable medium of claim 16, wherein the instructions further comprise:
instructions for determining whether any of the at least one harvester rely on data to be supplied from at least one other harvester, and
instructions for automatically loading and invoking the at least one other harvester when any of the at least one harvester are determined to rely on the data supplied from the at least one other harvester.

19. The tangible machine-readable medium of claim 16, wherein at least some of the at least one harvester further comprise:
instructions for providing information to one of an application or a network service based on the digital image file, and
instructions for receiving at least a portion of the harvested data from the one of the application or the network service in response to providing the information to the one of the application or the network service.

20. The machine-readable medium of claim 16, wherein:
at least some of the at least one harvester further comprise:
instructions for providing information to one of an application or a network service based on the digital image file, and
instructions for receiving at least a portion of the harvested data from the one of the application or the network service in response to providing the information to the one of the application or the network service, wherein:
the one of the application or the network service includes one of a scheduling application, a facial recognition application, or an online search engine, and
the machine-readable medium further comprises:
instructions for categorizing ones of the at least one new item of metadata as either being intrinsic to the digital image file or derived from at least one other data source.
